(19) United States
(12) Patent Application Publication
(10) Pub. No.: US 2013/0085827 A1
(43) Pub. Date: Apr. 4, 2013

(54) METHOD FOR REDEEMING ELECTRONIC COUPONS

(71) Applicant: Connie Lynn Jenkins, Windsor, CA (US)

(72) Inventor: Connie Lynn Jenkins, Windsor, CA (US)

(21) Appl. No.: 13/689,003

(22) Filed: Nov. 29, 2012

Related U.S. Application Data
(63) Continuation-in-part of application No. 12/806,307, filed on Aug. 9, 2010.
Application No. 12/806,307 is a continuation-in-part of application No. 12/800,562, filed on May 17, 2010, now abandoned.

(51) Int. Cl. G06Q 30/02

(52) U.S. Cl. CPC G06Q 30/0239; G06Q 30/0225; G06Q 30/0211
USPC 705/14.13; 705/14.39; 705/14.26

(57) ABSTRACT

A merchant provides a consumer with its email address along with at least a portion of one or more images of coupons. The consumer selects a desired coupon for redemption and sends an email to the merchant attaching the image or a portion of the image, or the URL or a Quick Response Symbol (QR code) of the coupon. The merchant, upon receipt, verifies the authenticity of the coupon and redeems it if valid. The merchant accumulates and stores emails from consumers who have sought redemption of coupons. These accumulated consumer emails and email addresses are analyzed to determine how the emails and/or email addresses can used by the merchant for communicating with consumers by email to promote the merchant's goods and services.

This application is related as a continuation in part (CIP) to prior patent applications Ser. No. 12/800,562 that was filed on May 17, 2010 by the same inventor and Ser. No. 12/806,307 that was filed on Aug. 9, 2010 of which it hereby claims the dates of priority.

### BACKGROUND OF THE INVENTION

1. Field of the Invention

The present invention, in general, relates to redeeming coupons and, more particularly, to redeeming a coupon by use of an Internet-accessible mobile electronic device or cell phone.

The art of redeeming paper (i.e., physical) coupons is well known. People have long been clipping coupons from newspapers, sales flyers, and other printed matter sources for later redemption from a merchant for goods or services. Typically, the person takes the paper coupon to the retail merchant and presents the coupon at the time of paying for the goods or services. Sometimes, the merchant may request earlier presentation of the coupon, for example, before the ordering of a discounted dinner at a restaurant.

Whatever benefit the coupon provides is then given to the presenter. Each coupon is unique in that it provides a specific stated benefit that is not generally available without presentation of the coupon. Most coupons are single use, meaning that whatever benefit is offered by the coupon is only provided one time. In other words, the same presenter cannot obtain and present multiple identical coupons and obtain the same benefit multiple times.

Additionally the benefit, whatever it may be, is usually only offered for a predetermined and therefore limited period of time, after which time the benefit offered by the coupon expires rendering the coupon null and void and of no effect. Typically, an expiration date indicative of the last day that the coupon can be redeemed is printed on the paper coupon.

The most common benefit offered by a coupon is a reduction in the price of select goods or services. For example, the coupon might offer a reduction in the price charged for a certain type of a television set that a merchant was offering for sale if the consumer presented the coupon to the merchant at the time of sale. Another example might include a reduction in the amount charged by a car wash for a particular level of automotive cleaning services that they offered. Virtually any benefit imaginable can be offered by the merchant for virtually any type of goods or services that the merchant provides.

Coupons may also provide their benefit in a great variety of ways. For example, a coupon may include an offer to purchase one item at a certain price, usually at the item's normal retail price, and then allow the redeemer of the coupon to receive an additional identical item or, alternately, to receive a different type of item from the merchant at a reduced price or even for free.

For example, a coupon from a fast-food restaurant may offer the redeemer an opportunity to purchase a certain type of sandwich and then receive a second identical sandwich at half-price, but only if the coupon is presented at the time of ordering. It is also possible that the fast-food restaurant may, instead, elect to offer the second identical sandwich for free (without charge) providing the coupon is presented at the time of ordering.

As mentioned earlier, most coupons include an expiration date. Therefore, to obtain whatever benefit was offered by the coupon, the coupon would, of course, need to be redeemed (i.e., presented to the merchant) prior to its expiration date.

Alternately, the fast-food restaurant may offer a different food item either at a reduced cost or without charge. Examples could include the fast-food restaurant offering the coupon redeemer a free drink or a free order of French fries along with the purchase of the certain type of sandwich providing that the coupon is, again, presented to an employee of the fast-food restaurant (or merchant) at the time of ordering.

If the coupon appertains to a service rather than a product that is provided by the merchant the coupon may, instead, include an offer to purchase a first level of service at a certain price, usually at the normal retail value or amount that is typically charged for the service, and then allow the redeemer to receive an additional similar or a lesser level of service at a reduced charge or perhaps without additional charge.

An example could include a carpet cleaning company that offers the cleaning of a carpet in a certain size room at a personal residence or at a business location for a certain price and the cleaning of a second, similar or smaller size of room for a reduced amount or even for free.

Basically, a coupon provides an increased incentive for a consumer to purchase goods or services from a particular vendor, provider, or merchant over the goods or services offered by another merchant. The expiration date associated with most coupons creates in the mind of the consumer the resemblance of a sense of urgency, as the offer is not indefinite.

Accordingly, the use of coupons benefits the consumer through lower prices for goods and services that are purchased or by providing the consumer with additional goods and services that are provided at a reduced charge or even without additional charge.

The use of coupons benefits the merchant by increasing business during the time that the coupon is still valid. As a result consumers may find sufficient motivation to break preexisting established shopping patterns that include the use of a specific merchant for certain goods or services in favor of trying a new merchant who is offering the same (or similar) goods or services because the new merchant is also providing an increased incentive as specified by the terms and conditions of the new merchant's coupon.

The merchant benefits because coupons tend to be effective in quickly driving new business to the merchant. Unlike advertising in a telephone directory that can take several months to print, the benefit a coupon provides is often available for use within days, as soon as the coupon is delivered by mail or as a part of the advertising that is included in a newspaper or periodical.

The specified expiration date also provides the merchant with a level of safety by including an end date for their coupon-based offering. This can be especially important to some merchants who, in an attempt to win new customers, may provide such a powerful incentive in a coupon as for the coupon to be a “loss-leader” to the merchant whereby, for every coupon that is redeemed, the merchant experiences a monetary loss.

The merchant may, nevertheless, wish to do so because the merchant strongly wishes to increase the size of their customer base. Therefore, the merchant is relying on the expected repeat business from some of those customers who redeem the coupon as a way of offsetting the initial loss that occurs from a “loss-leader” type of coupon. However, the merchant would certainly not wish to continue with any type of an offer indefinitely that resulted in a loss rather than in a profit. A coupon with an expiration date may provide the necessary incentive to draw new customers to the merchant and serve as an ideal solution for quickly and dramatically increasing the number of customers that purchase goods or services from the merchant.

While coupons provide many benefits and advantages to both consumers and merchants, coupons also have certain disadvantages. Historically coupons have tended to be paper documents that the consumer must first obtain. The consumer obtains the coupon through a variety of possible ways, such as by receipt of the coupon through the mail where the merchant mails the coupon directly to the consumer. This is an example of direct mailing. The mailing of coupons to a wide sampling of consumers who either have or have not been specifically pre-qualified as likely customers is a common occurrence. This is an example of general or mass mailing of the coupons.

Alternately, the merchant may utilize a more selective mailing approach by sending coupons only to those consumers who were obtained from a data base of potential customers that are believed to be more likely than others to desire the goods or services offered by the merchant.

As mentioned above an especially common way of obtaining coupons requires consumers to extract (i.e., clip) coupons from newspapers, periodicals, or flyers. Also, certain books may be offered for sale which include a variety of single-use coupons that discount the goods and services offered from a variety of different merchants. The merchants may provide vastly different types of goods and services or they may provide very similar types of goods and services. An example of a book of coupons from merchants providing similar or related products might include coupons that discount the cost of a meal at a variety of different restaurants. Also, coupon books tend to be limited to a particular geographic area. This means that when the consumer is traveling outside the geographic area covered by the coupon book the coupons therein are of no value to the consumer. Ideally, a solution is needed whereby the consumer can redeem coupons wherever they may be located.

Another disadvantage to the consumer regarding the use of coupon books (with paper coupons) is that they are generally sold to the consumer. This alone deters many consumers. However, those who do purchase coupon books do so because they expect to more than recoup their initial investment by using a number of the coupons in the book over the course of the time that the coupon book is valid, typically for one-year, and thereby save considerably more money in dining out expenses, for example, than the initial cost of the coupon book. However, many consumers dine out infrequently and, therefore, are not likely to invest in a coupon book.

Another disadvantage of a paper-based coupon book is that the consumer only has a limited time to redeem the coupons. As such, the consumer may feel pressure to redeem the coupons in a coupon book at a faster rate than they find is comfortable. Another significant disadvantage of a coupon book is that its value decreases steadily after printing. At the time of printing the coupon book will have its greatest value because the coupons therein will be valid for the longest remaining amount of time. However, if a coupon book that is valid for one-year at the time of printing only has one-month of time remaining until its expiration, it will have little value. In such a situation either the remaining copies of the coupon book will need to be severely discounted or the remaining copies in print will need to be distributed to consumers for free.

Alternately, when making a routine purchase of any kind the consumer may be provided with a coupon discounting future goods and services that is included along with a receipt for the goods or services that the consumer is currently receiving. The benefit provided by such a coupon is to create an incentive that may cause the consumer to return to the merchant. There are also other ways in which a consumer can obtain paper-based coupons.

Once obtained, the consumer must remember to take the coupon to the merchant for redemption. Without the paper coupon in hand, merchants are either reluctant or unable to provide the benefit offered by the coupon.

Another disadvantage to the consumer regarding paper coupons is that the consumer may forget or not notice the expiration date that is imprinted on the coupon. Therefore, the consumer may attempt to redeem the coupon after the coupon has expired. This can be awkward and embarrassing for both the consumer and the merchant. While the merchant is earnestly desirous of pleasing the consumer and certainly not wishing to offend the consumer, merchants are generally unable to permit the redeeming of an expired coupon.

This can annoy a consumer who might have traveled far with the intent of using the coupon. Therefore, the consumer may leave feeling dissatisfied with the merchant. The consumer may decide to never again attempt to do business with that particular merchant. Without knowing that they are doing so, the consumer may be projecting the cause of their dissatisfaction on the merchant blaming the merchant for poor customer service in the handling of the situation when, in fact, the merchant was only being consistent in the application of rules governing the redemption of coupons.

Accordingly, merchants have a long-standing and heretobefore unmet need of providing their existing and new customers with coupons that are not yet expired, yet still being able to control and limit the duration (i.e., the expiration date) of the coupon. This creates a set of contradictory objectives that appear to be mutually exclusive of one-another. In other words, the merchant does not wish to provide a coupon that will never expire, yet the merchant also wants to provide the consumer with a coupon that will not have expired, regardless of when the consumer is presenting it for redemption. Satisfying both objectives sounds impossible to achieve and it is impossible to achieve with a paper coupon that includes a printed expiration date, thereon.

Also, paper coupons contribute enormously to the need for paper, which translates into a significant need for more trees to make the required paper stock that the coupons are made of. This increases deforestation and the release of greenhouse gases, in particular the release of increased amounts of carbon dioxide which have a deleterious environmental impact. Accordingly, there is a need for providing the benefits afforded by coupons while decreasing the usage of paper coupons.

There is another problem associated with the use of coupons and that is caused by the merchant's employee giving the benefit (i.e., the discount, free merchandise or service) provided by the coupon to people who do not actually present the coupon, such as to their friends. Some merchants do not retain the paper coupons or compare the number of coupon-based discounts provided with the number of paper coupons that have been redeemed.

There are many other ways that an employee of the merchant can improperly provide a coupon benefit to someone not presenting the coupon. For example, the coupon may include a bar code or a coupon reference number that is entered (into a cash register or point of sale terminal) at the time of sale and, upon entry, provides authorization for the discount, as provided by the coupon. However, the merchant's employee may use a previously redeemed coupon and simply reenter the bar code or reference number as many times as they wish. In this way the employee can provide the coupon discount to a number of customers who do not actually present a coupon.

Not only is this likely to occur for friends, but in certain professions the merchant's employee may routinely offer any available coupon-based discount to customers who do not present the coupon simply to please the customer. This may be done in hope of later making a sale or receiving a greater gratuity or tip amount. For example, a waiter at a restaurant may offer the coupon discount to customers who do not have the coupon because the waiter expects to receive a bigger tip (gratuity) from the especially pleased and now somewhat indebted customer.

This practice is essentially the equivalent of the waiter taking money away from the merchant (i.e., a loss of the greater amount of money that the customer would have otherwise had to pay for the non-discounted dinner) and instead giving to the waiter some of the money that was rightfully due to the merchant as payment from the customer (who did not present the coupon) by way of the waiter receiving an increased gratuity amount from the customer. It is tantamount to an insidious form of theft.

To compound this problem, the ability of the merchant who wishes to track and physically retain the paper coupons that have been redeemed may be flawed. Therefore, many merchants accept the fact that many more coupon discounts will be awarded to customers than the number of paper coupons that are retained. Some merchants make no attempt to correlate the number of paper coupons on hand with the number of coupon discounts that have been awarded. Accordingly, they may have their employees enter the bar code or reference number into the register terminal to obtain the discount and then discard the actual physical coupon. This practice leaves the merchant with no way of determining whether or not their employees are routinely giving coupon discounts to customers who do not actually present coupons.

Adding to the problem the merchant has no way of determining which of the merchant's employees are giving away coupon discounts without the coupons. Continuing with the earlier example, if the restaurant has ten different food servers (i.e., waiters) working during any given dinner shift and if the merchant has reason to believe that ten unwarranted coupon discounts occur on average per dinner shift, the merchant cannot know whether each server is giving out one unauthorized coupon discount per shift, whether only one of the servers is responsible for the ten unauthorized coupon discounts, or if only a few of the servers involved.

There is no present effective way to track this form of abuse and identify the responsible server or servers. Neither is there a way of accurately determining the total number of unauthorized coupon discounts that occur per shift. At present, the best the merchant can hope to do is to retain and track, as best as possible, the paper coupons received per shift, compare that number to the number of discounts awarded per shift, and guess at how many of the coupon discounts that were awarded in excess of the number of coupons retained are believed to be caused by unauthorized coupon discounts.

Accordingly, there is a need for merchants to be able to reduce the number of unauthorized coupon discounts that are awarded. Similarly, there is a need for merchants to increase the number of legitimate coupon discounts that are awarded (because these promote the growth and expansion of business).

Also, there is a need for merchants to be able to track coupon abuse to the employee level, sufficient to positively identify those who are responsible.

In addition to identifying the offending employees, the merchant would benefit from an ability to track the percentage of their clientele that redeem coupons and, over the course of time, note changes in that percentage. A change in percentage can indicate a more effective coupon advertising strategy. However, the merchant must be able to verify that the increase is due to an increase in customers who actually present the coupons and that it is not due to servers granting unauthorized discounts.

Similarly, an increase in the percentage of customers redeeming coupons when no change in the coupons has occurred may be indicative of an increase in unauthorized coupon discounts being awarded to customers who do not actually present coupons. For example, if on average thirty percent of a restaurant's clientele are expected to present a coupon the merchant would be interested if any spike in that percentage were to occur.

Also, there has been steady growth over the last many years in the usage, speed and capability of mobile computing devices and, in particular, in cell phone capabilities including the ability of cell phones and mobile computing devices to communicate over the Internet. There is also a growing need to effectively utilize mobile computing devices and cell phones in ways that benefit both the consumer and the merchant and which promote the use of coupons while helping to ameliorate certain of the disadvantages that are associated with coupon collection and redemption.

Another problem associated with coupons is that the customer can lose or forget to bring the coupon to the merchant. The customer is then unable to redeem the coupon. Instead of the customer being pleased with the merchant, as mentioned above, the customer may feel resentment toward the merchant for an undesirable situation that was not of the merchants doing. There is a need to not penalize customers who forget to take or who lose their coupons.

Additionally, merchants are increasingly seeking to obtain contact information for their clients and, in particular, to obtain the email addresses of their clientele. This, at present, can only be obtained by asking or in some way soliciting the customers for their email address. Many customers are reluctant to give out their email address if asked because they may not want to receive email solicitations. Merchants desire accumulation of the email addresses of their customers as it permits the merchant to periodically send an email to their customers about special sales or promotions that may be ongoing or upcoming. Having customer email addresses can, thereby, be used to increase sales of goods or services by the merchant.

Sending emails to previous customers has numerous advantages. First, it is not a general or mass-mailing but is, instead, a solicitation directed at a select group that, potentially, may be most likely to take avail of the current offering and that group is previous clients. Second, the cost to send emails is very low compared to the cost to communicate by way of printed matter and/or mail delivery.

Accordingly, there is a need for a way for merchants to obtain the email address of an increasing number of their customers. Additionally, there is a need for a merchant to obtain a customer's email address without it appearing to be a solicitation on the part of the merchant. There is also a need for a merchant to obtain a customer's email address without the customer necessarily being aware that they are providing their email address to the merchant. There is a further need for a merchant to obtain a customer's email address in a way in which the customer feels delighted, even appreciate of the merchant.

Also, a consumer may drive by a merchant and have it dawn upon himself that the goods or services of the merchant are desired. However, the consumer may not have earlier thought that they would be doing business with this particular merchant. Therefore, they would not have thought to obtain or bring any coupon that the merchant might currently be offering.

Additionally, there are times when the consumer may have a choice of utilizing the services of any of a number of competing merchants. An example is when a person or a couple decides to have dinner at a restaurant. The person or couple can choose to have their dinner at any of a number of different restaurants. If certain of those restaurants are offering coupon discounts, all other factors being equal, the person or couple may well prefer to dine where they can enjoy the discounted meal. However, the person or couple may not know which restaurants are currently offering a coupon discount and, even if they were so informed, the person or couple would be unable to timely obtain the coupon and legitimately receive its discount.

The waiter might even inquire of the person or couple if they have a coupon and wish to provide a coupon to them but, at present, the waiter may not be able to provide the person or couple with a coupon. It is important to note that the merchant, under such a situation, would likely want to provide a coupon to the person or couple and thereby receive their business rather than have the person or couple go to another restaurant that can, perhaps, offer them a discount or a coupon. For situations like this some merchants may actually have on hand a quantity of paper coupons that they can then give to the person or couple to redeem.

Accordingly, there is a need to provide consumers with a method for accessing and redeeming a coupon in real-time, when the need for the coupon is realized. Similarly, there is a need whereby consumers can identify which merchants are offering a coupon discount and quickly obtain the coupon in order to receive the discount.

Accordingly, there exists today a need for a method for redeeming electronic coupons that helps to ameliorate the above-mentioned problems and difficulties as well as ameliorate those additional problems and difficulties as may be recited in the “OBJECTS AND SUMMARY OF THE INVENTION” or discussed elsewhere in the specification or which may otherwise exist or occur and are not specifically mentioned herein.

For all the reasons stated herein and for other reasons, as well, it is important to also keep in mind that the merchant needs some way of setting or otherwise of controlling the expiration date of a coupon, whether it be a paper or electronic type of the coupon. In particular, it is especially desirable for the merchant to be able to cause a coupon to expire at will. This is, of course, impossible with a paper coupon that is printed in advance and which contains a printed expiration date. An example in which a merchant may experience a sense of urgency to immediately expire a coupon would occur if the coupon was, as described above, a loss-leader and if the loss-leader coupon was far more popular than anticipated. The merchant would not then want to continue to endure losses after the targeted number of new customers had been realized.

As various embodiments of the instant invention help provide a more elegant solution to the various problems and difficulties as mentioned herein, or which may otherwise exist or occur and are not specifically mentioned herein, and by a showing that a similar benefit is not available by mere reliance upon the teachings of relevant prior art, the instant invention attests to its novelty. Therefore, by helping to provide a more elegant solution to various needs, some of which may be long-standing in nature, the instant invention further attests that the elements thereof, in combination as claimed, cannot be obvious in light of the teachings of the prior art to a person of ordinary creativity.

It is therefore desirable to be able to redeem electronic coupons that satisfy many of the above longstanding needs for both consumers and merchants. It is desirable to use a cell phone or mobile computing device to determine the availability of coupons and to also present the electronic coupon for redemption. In order to do so, the cell phone or the mobile computing device must access the desired information. This is typically done over the Internet although in some situations a local area network provided by the merchant at the merchant's place of business could also be utilized.

When obtaining information or an electronic coupon over the Internet and while using the cell phone or the mobile computing device the time that is required to obtain the information or the electronic coupon becomes an issue as most service plans for cell phones and mobile computing devices levy charges on the consumer based on the usage (i.e., the amount of time in minutes) experienced by the cell phone or mobile computing device as the wireless network of the service provider is utilized to access the Internet. In other words, the longer it takes to access the information and obtain the electronic coupon, more minutes are used and the more the consumer must pay.

Ideally, the consumer would obtain the electronic coupon using as little wireless (i.e., air time) as possible. Most service plans for wireless devices (i.e., for cell phones or mobile computing devices) offer a fixed number of minutes of usage for a certain monthly fee (i.e., at a predetermined cost per minute) and then charge a considerably higher amount, or surcharge, per minute of usage that is in excess of the fixed number of plan minutes, it is desirable for the consumer to keep the total number of minutes utilized under the monthly maximum amount and thereby avoid having to pay any of the additional surcharge fees for extra minutes.

The faster an electronic coupon can be obtained and presented to a merchant the less likely it becomes that doing so will cause the consumer to exceed his or her monthly minute allotment. If the allotment is not exceeded, as far as the consumer is concerned, the act of finding and obtaining the electronic coupon for presentation to the merchant is without cost.

It is also desirable by the merchant to keep track of all electronic coupons that are being redeemed in order to satisfy many of the merchant's needs, as stated hereinabove. However, the merchant may not necessarily want to sort through a large database of electronic images that the merchant has received, typically in the form of emails sent by the consumer with an image of the coupon or a portion of the image of the coupon attached thereto, in order to determine if each coupon redeemed is, in fact, valid.

To do so the merchant would have to carefully scrutinize the details of each coupon image in order to discern whether or not the coupon was valid at the time of its redemption. For example, if a consumer wanted to improperly extend a discount offered by a merchant, the consumer, under certain situations, could obtain copy and paste an image of the merchant's coupon at a location (i.e., a URL or computer database of the consumer) that the consumer alone has access to or the ability to change content. The consumer could then go the consumer's URL, cut and paste an image of the coupon on their cell phone and then email that image to the merchant.

At the time of redemption the merchant might not be able to discern if the coupon was improper because the image of the electronic coupon that is presented to the merchant at the time of redemption would appear tiny on the small display screen of the consumer's cell phone or mobile computing device. The merchant might not be able to read the detailed information on the electronic coupon, for example, its expiration date. Therefore, the merchant could be deceived into offering an expired discount.

Ideally, the merchant would desire a means of determining whether or not an electronic coupon that is being redeemed is valid at the time of its redemption. That way the merchant could detect improper redemption attempts and not offer the discount. To do so, however, an automated system would be required for all moderate to high volume types of businesses as manual verification would be too time consuming and, therefore, not practical.

If the merchant was, for any reason, unable to discern improper electronic coupon redemption attempts at the time they occurred, the merchant would still desire a quick and easy way or an automated method of later determining whether or not an electronic coupon that was redeemed was, in fact, valid. Furthermore, if the merchant could discern the exact time that the improper redemption occurred, the merchant might even be able to correlate the redemption with a particular consumer to with a few consumers. If it recurred, the merchant could then, conceivably, narrow the field down to the actual offender who, alone, was present at the time of both improper redemption attempts.

Also, some merchants offer multiple coupons at the same time as they discount their goods and services in a variety of different ways. If more than one type is simultaneously being offered by the merchant for any given service or type of goods, the merchant will want to track the number of redemptions that are occurring for each coupon type. Again, the merchant would, ideally, desire an automated way of tracking redemption numbers and patterns for all currently available electronic coupon offerings.

Therefore, merchants have a need for a method of redeeming electronic coupons that permits easy tracking of coupons including different types of coupons, is useful in discerning proper and improper redemption attempts at the time of redemption or later doing so, and which can detect patterns of redemption that the merchant can use to determine which coupon types are the most effective and other patterns of redemption. This information can be used by the merchant for many purposes, including enhancements in the stocking of goods and manpower (i.e., staffing) in order to provide the desired goods and services.

Clearly, such a method would be useful and desirable.

2. Description of Prior Art

Various methods of dispensing or providing items are, in general, known. For example, the following patents describe various types of these devices, some of which may have relevance as well as others which may not have particular relevance to the invention. These patents are cited not as an admission of their having any particular relevance to the invention but rather to present a broad and diversified understanding regarding the current state of the art appertaining to either the field of the invention or possibly to other related or distal fields of invention.
U.S. Pat. No. 6,311,171 to Dent, that issued on Oct. 30, 2001; and
U.S. Pat. No. 6,293,540 to Kovacs, that issued on Sep. 25, 2001.

While the structural arrangements of the above described devices may, at first appearance, have similarities with the present invention, they differ in material respects. These differences, which will be described in more detail hereinafter, are essential for the effective use of the invention and which admit of the advantages that are not available with the prior devices.

### OBJECTS AND SUMMARY OF THE INVENTION

It is an object of the present invention to provide a method for redeeming electronic coupons that is economical.

It is also an important object of the invention to provide a method for redeeming electronic coupons that allows consumers (i.e. a customer or customers) to obtain coupons when desired.

Another object of the invention is to provide a method for redeeming electronic coupons that allows consumers to access coupons when desired.

Still another object of the invention is to provide a method for redeeming electronic coupons that allows consumers to redeem coupons when desired.

Still yet another object of the invention is to provide a method for redeeming electronic coupons that allows consumers to obtain the benefit of a coupon by use of a mobile computing device.

Yet another important object of the invention is to provide a method for redeeming electronic coupons that allows consumers to obtain the benefit of a coupon by use of a cell phone.

Still yet another important object of the invention is to provide a method for redeeming electronic coupons that allows a merchant to electronically provide a coupon to a consumer when the consumer wishes to obtain the coupon.

A first continuing object of the invention is to provide a method for redeeming electronic coupons that allows a merchant to verify that an image of the coupon was available to a consumer on a mobile computing device or cell phone and that the consumer presented the image of the coupon to the merchant or to an employee of the merchant at the time that the discounted goods or services were provided to the consumer.

A second continuing object of the invention is to provide a method for redeeming electronic coupons that provides a merchant with a record confirming that a consumer was in proper possession of the coupon.

A third continuing object of the invention is to provide a method for redeeming electronic coupons that provides a merchant with a record confirming that a consumer was in proper possession of the coupon and which also provides the email address of the consumer to the merchant.

A fourth continuing object of the invention is to provide a method for redeeming electronic coupons that provides a merchant with a way of associating the redemption of electronic coupons to a particular employee of the merchant.

A fifth continuing object of the invention is to provide a method for redeeming electronic coupons that provides numerous benefits to both a consumer and to a merchant.

A sixth continuing object of the invention is to provide a method for redeeming electronic coupons that provides a way for a merchant to obtain an email address of a customer (i.e. a consumer) and allows the merchant to accumulate and store such emails and then analyzing the stored emails to determine what responses might be sent to consumers that would benefit the merchant.

A seventh continuing object of the invention is to provide a method for redeeming electronic coupons that provides a way for a merchant to obtain an email address of a customer without having to ask (i.e., solicit) the customer for the email address.

An eighth continuing object of the invention is to provide a method for redeeming electronic coupons that provides a way for a merchant to obtain an email address of a customer in a manner such that the customer is happy to provide the email address because the customer is benefiting in the process.

A ninth continuing object of the invention is to provide a method for redeeming electronic coupons that provides a way for a merchant to obtain an email address of a customer in a manner such that the customer may not necessarily even know that the customer is also providing their email address to the merchant.

A tenth continuing object of the invention is to provide a method for redeeming electronic coupons that decreases the release of greenhouse gases into the atmosphere.

An eleventh continuing object of the invention is to provide a method for redeeming electronic coupons that helps to decrease the consumption, and therefore, the destruction of trees.

A twelfth continuing object of the invention is to provide a method for redeeming electronic coupons that is beneficial to preserving the environment.

A thirteenth continuing object of the invention is to provide a method for redeeming electronic coupons that helps to lessen global warming.

A fourteenth continuing object of the invention is to provide a method for redeeming electronic coupons that reduces the amount of airtime or minutes of use by a cell phone or a mobile computing device to email confirmation of a consumer's possession of the electronic coupon at the time of redemption.

A fifteenth continuing object of the invention is to provide a method for redeeming electronic coupons that reduces the amount of time necessary to determine if a redeemed coupon is valid.

A sixteenth continuing object of the invention is to provide a method for redeeming electronic coupons that can be used to provide a merchant with information at the time of redemption of the coupon as to the validity of the coupon.

Briefly, a method for redeeming electronic coupons that is constructed in accordance with the principles of the present invention includes a first step of a consumer obtaining access to an image of a coupon on a mobile computing device or cell phone over the Internet. The coupon could be located on a web site of the merchant or on any other web site that is offering access to the coupon over the Internet. The consumer is then provided with an email address of the merchant. The consumer then attaches the address (URL) where the coupon can be viewed to an email that they are constructing and about to send to the email address of the merchant. The consumer then sends the email to the merchant. The email that is received by the merchant provides confirmation to the merchant that the consumer was in possession of the image of the coupon and that the consumer was, therefore, entitled to the benefit provided by the coupon. The email also provides the merchant with the email address of the consumer and the time of transmission of the email. The time of transmission can be used for additional tracking and verification purposes as well as for analysis of consumer trends and patterns, such as helping the merchant to identify a consumer preference for certain types of coupon-related benefits or helping the merchant identify peak and low periods of coupon redemption or business, in general. If desired, according to a modification the merchant provides each of the merchant's employees with a unique merchant employee email address. Each customer served by any of the employees and who is sending an email to the merchant in order to obtain the benefit provided by the coupon is provided with the employee's own unique merchant employee email address. The merchant, not the employee, has access to the content of the email messages sent by the consumers and which are received over the Internet at the merchant employee email address. This allows the merchant to track and verify the legitimate use and redemption of coupons for each of the merchant's employees. The URL that is received by the merchant at the merchants email can be forwarded in real time to the merchant to confirm the validity of the coupon redemption or software can be provided to the merchant to automatically verify the URL of incoming emails, prompt the merchant in real time when the URL is correct or incorrect, as desired, and perform statistical analysis of coupon redemption patterns based on the URL. The URL can be the actual alphanumeric name where the email is sent or it can be encoded in any preferred format including a quick response (QR) code.

### BRIEF DESCRIPTION OF THE DRAWINGS

FIG. 1 is a view in perspective of a consumer using a method for redeeming electronic coupons and an electronic device to obtain an image of a coupon over the Internet, which is shown in block diagrammatic view, for visual presentation of the image of the coupon to a merchant or employee of the merchant and for attachment of an address (URL) where the image of the coupon can be seen to an email that the consumer sends to the merchant in order to obtain the benefit provided by the coupon.

FIG. 2 is a block diagram of the steps of a method for redeeming electronic coupons.

FIG. 3 is a plan view of an electronic coupon as it could appear at a website.

FIG. 4 is a plan view of an address or URL where an electronic coupon can be viewed over the Internet encoded in a quick response (QR) symbol.

FIG. 5 is a block diagram of an embodiment of a merchant's system to accumulate and store emails sent by consumers redeeming the merchant's coupons, and to analyze the emails and email addresses to determine how the merchant can further benefit its business.

FIG. 6A is a flow diagram which shows how consumer emails are accumulated and stored by a merchant, how a merchant analyzes the emails and email addresses and determines what beneficial actions the merchant might engage in using the stored emails.

FIG. 6B is a flow diagram which shows how a merchant validates a consumer coupon and uses the consumers email information for future tracking.

### DETAILED DESCRIPTION OF THE INVENTION

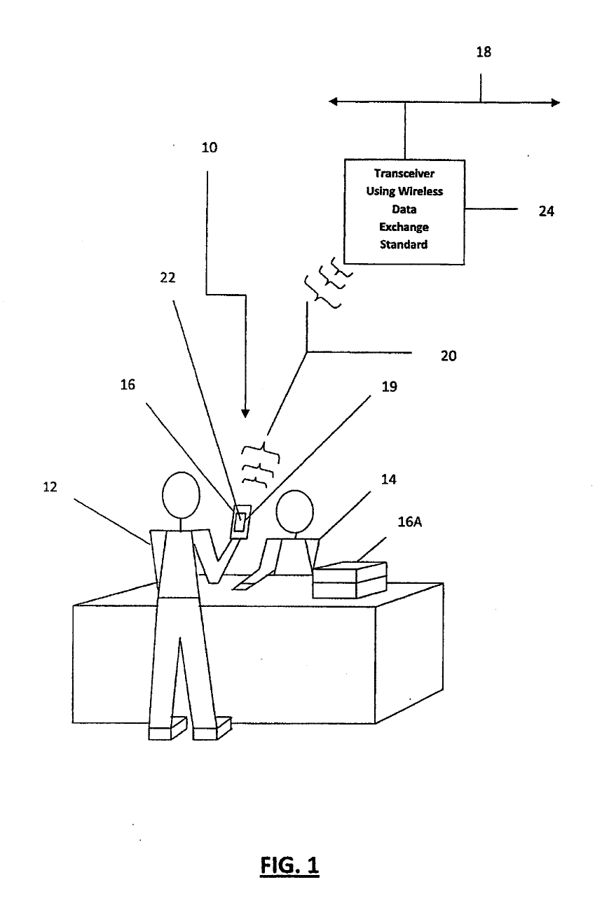

Referring on occasion to both of the FIGURE drawings and now, in particular to FIG. 1, is shown the utilization of a method for redeeming electronic coupons, the method being identified in general, by the reference numeral 10.

A consumer 12 is located at the place of business of a merchant 14. The merchant 14 may provide any type of product, service, or combination thereof. The consumer 12 is using a mobile computing device 16 that is capable of mobile communication and access over an Internet 18 (i.e., more commonly introduced as “the Internet” 18), including the downloading and transmission of data over the Internet 18.

The mobile computing device 16 may include any preferred type of device that includes a display 19. Examples include, but are not limited to any type of a cell phone, any portable laptop, notebook, netbook, or other type of portable computer, any portable personal data assistant (PDA), any portable device designed primarily for the download and display of books newspapers or for the display of other content, such as the Kindal™, Nook™, iPad™, any BlackBerry™, or other type of computing device that is mobile and wherein the mobile computing device 16 is capable of communication over the Internet 18.

The mobile computing device 16 may utilize any preferred method for accessing information via the Internet 18. Two currently popular methods for mobile access to the Internet 18 include radio frequency communication by Wi-Fi™ and communication utilizing a standard commonly referred to as “3G”. A standard recently introduced is known as “4G”. The mobile computing device 16 may also utilize the 4G standard as well as any other future standard that is developed including any modification to any existing standard.

Similarly, one or more applications (each commonly referred to as an “app”) are expected to be developed for inclusion in the mobile computing device 16. The “app” would include the software necessary to produce a visible image (commonly referred to as an “icon”) that would appear on the display 19 screen of the mobile computing device 16, possibly alongside other icons that are used for the selection of other “apps”. If the user selects the “app” that was developed for use with the method for redeeming electronic coupons 10 on the mobile computing device 16 the “app” will be activated and will automatically access a desired website, for example, the website where an image and/or URL of a coupon 22 can be found. Use of the image of the coupon 22 and the URL is described in greater detail, hereinafter.

The ability of the mobile computing device 16 to access information via the Internet 18 is accomplished by the compliance of the mobile computing device 16 with an agreed upon protocol or standard governing a wireless exchange of data 20. The standard governing the wireless exchange of data 20 is shared by a transceiver, identified by the reference numeral 24, that is in communication with the mobile computing device 16.

The transceiver 24 may be located proximate the mobile computing device 16, for example, at the place of business of the merchant 14 of it may be located any desired distance away from the mobile computing device 16 that still permits the exchange of data between the transceiver 24 and the mobile computing device 16. The transceiver 24 provides the mobile computing device 16 with the desired connection to the Internet 18.

The transceiver 24 may be connected directly (as in hard-wired) to the Internet 18 or the transceiver 24 may communicate through one or more intermediate devices (not shown) in order to obtain access to the Internet 18. Because the mobile computing device 16 is able to both send and receive data from the transceiver 24 the mobile computing device 16 can be said to also include a (radio frequency or other broadcast modality) transceiver-like capability.

Any currently existing or future type of the wireless exchange of data 20 (i.e., including, but not limited, to RF) is possible for use with the method for redeeming electronic coupons 10. Of the two common standards mentioned, Wi-Fi™ is a trademark of the Wi-Fi Alliance that manufacturers can utilize to certify products which belong to a class of wireless local area network (WLAN) devices that are based on the IEEE 802.11 standards. The term Wi-Fi™ may be used as a synonym for adherence to the IEEE 802.11 standard(s).

The name “3G”, which stands for “3rd Generation”, includes compliance with the International Mobile Telecommunications-2000 (IMT-2000) family of standards for mobile telecommunication devices by the International Telecommunication Union. It generally applies to wireless broadband data services although certain aspects of the family of standards can also apply to non-mobile devices. In general, 3G is heralded as being capable of providing a higher transmission rate for the exchange of wireless data. The present invention is applicable to 4G networks and any future mobile communication formats, wireless broadband communication standards and any communication that apply.

During use of the method for redeeming electronic coupons 10, the consumer 12 is not involved in the use of any type of a paper coupon (not shown). Accordingly, the consumer 12 does not have to look for, find, cut, retain, and remember to bring a paper coupon to the merchant 14. Neither will the consumer 12, when using the method for redeeming electronic coupons 10, ever find himself or herself in a situation of presenting for redemption an expired paper coupon.

Instead, when using the method for redeeming electronic coupons 10, the consumer 12 will be obtaining, displaying, and sending by way of an email over the Internet 18 an address or URL of the coupon 22 that the consumer 12 has obtained (i.e., downloaded) from the Internet 18. No paper is involved, therefore, conservation of resources (i.e., trees, landfill space), and the reduction of greenhouse gases are additional benefits provided by the method for redeeming electronic coupons 10.

The type of the coupon 22 that is created or utilized by the method for redeeming electronic coupons 10 is an electronic version. It can also be considered as being virtual or non-physical. However, the (electronic, virtual, or non-physical) coupon 22 must be available for presentation (i.e., It must be shown or available for showing) to the merchant 14 at the time of its redemption in order to receive from the merchant 14 a desired benefit, discount, additional item or service that presentation of the coupon 22 entitles the consumer 12 to receive.

Typically, the consumer 12 goes to the place of business of the merchant 14, whatever that business may be. The first step accomplished by the consumer 12 is to access a desired location on the Internet 18 that includes an image of the coupon 22, for example, a web page that includes the coupon 22 image thereon. The location that is accessed may be part of a web site that is provided and maintained by the merchant 14 or it may be from a web site that is provided and maintained by a third party (not shown).

Upon accessing the desired location (i.e., web page) of the website, the consumer 12 sees an image of the coupon 22. As described in greater detail below, the consumer shows the image of the coupon 22 (or offers to show it) as proof of its availability. After showing the coupon 22 the consumer uses a pointing device of the mobile computing device 16 to click on an image of the coupon 22. The software of the web page is written so that by the consumer clicking or otherwise selecting the coupon an Internet address or URL where the coupon can be viewed is obtained (i.e., extracted) from the web page. Use of the address or URL is described in greater detail hereinafter.

The image which appears on the display 19 of the mobile computing device 16 may include a view of the entire coupon 22 or a view of a portion of the coupon 22. If desired, the coupon 22 may be included as part of either an entire web page or portion of the web page that appears on the display 19.

In general, the size, amount, and specific part of the coupon 22 that is required to appear on the display 19 is a variable. Similarly, it is a variable as to whether or not some of the surrounding area that borders the coupon 22 is required to appear on the display 19. Basically, all that the merchant 14 is seeking is to ensure that a sufficient amount (i.e., portion) of the coupon 22, or the coupon 22 along with the bordering area, appear on the display 19 so that the merchant 14 can confirm that the coupon 22 is indeed a valid, current coupon 22 that the merchant 14 is now offering.

After obtaining an image of the coupon 22 on the display 19, the consumer 12 then provides the merchant 14 with an opportunity to view the display 19 and thereby confirm that the consumer 12 is in possession of the (nonphysical) coupon 22.

However, this act alone is generally insufficient for the merchant 14 to award the benefit provided by the coupon 22 to the consumer 12. This is because if all that were required is for the consumer 12 to show the coupon 22 appearing on the display 19 to the merchant 14, the merchant 14 would have no proof or record that confirms the fact that the consumer 12 actually was in possession of the coupon 22.

This can be better illustrated by the following consideration. For the purpose of illustrating the problem, it can be assumed that the merchant 14, as shown, may be the owner of the business or it may include an employee of the merchant 14.

It is possible then that the consumer 12 may be interacting with an employee of the merchant 14 instead of with the merchant 14, directly. If the consumer 12 is a friend or relative of the merchant's 14 employee, the employee might be inclined to give the benefit of the coupon 22 to the consumer 12 without the consumer 12 actually having obtained and presented the coupon 22 to the employee.

To prevent this from happening, after the consumer 12 has presented the image of the coupon 22 that is visible on the display 19 to the merchant 14 (or to the merchant's 14 employee), the consumer 12 is provided (by the merchant 14 or the merchant's employee) with an email address of the merchant 14. The consumer 12 is asked to attach the coupon 22 to the email prior to sending the email to the merchant 14. The act of sending the email with the coupon 22 attached to the email to the address that was provided by the merchant 14 is what entitles the consumer 12 to receive whatever benefit is provided by the coupon 22. In reality, according to the instant embodiment, an image of the coupon 22 is not actually sent to the merchant 14. As mentioned above, the address or URL where the coupon 22 can be viewed is what is sent to the merchant 14.

After seeing the coupon 22 on the display 19 of the mobile computing device 16 the merchant 14 (or employee) is then authorized to provide the benefit to the consumer 12. This may include discounting the amount charged for goods or services or providing additional goods or services to the consumer 12.

In general, no verification is necessary to confirm that the email was actually received by the merchant 14. However, it is possible that the consumer 12 failed to properly enter the merchant's 14 email address, in which case the merchant 14 would never receive the email or the attached URL of the coupon 22.

In certain instances, the merchant 14 may wish to be especially thorough and prevent this from happening. Accordingly, software at the merchant's 14 place of business can be designed and included to verify that actual receipt of the email, and possibly to verify that the address or URL of the coupon 22 is attached to the received email prior to a final authorization and acceptance of the coupon 22 and a providing of the benefit to the consumer 12.

The software for confirming receipt of the email (and the address and URL of the coupon 22, if desired) from the consumer 12 can be included in a system utilized by the merchant 14, such as in a system used by some restaurants and other business for order entry, pricing, and collection (i.e., receipt) of payment. Confirmation of receipt of the email would automatically enable the system to provide the coupon 22 benefit to the consumer 12.

If desired, a more simple system can be designed and included at the merchant's 14 place of business that, upon having detected receipt of the email, automatically provides the merchant 14 (or the merchant's 14 employee) with a “green light” authorizing release of the benefit. The more simple system need not be connected with or part of any other system of the merchant 14, although it can if so desired.

However, for most applications a mere statement by the consumer 12 confirming that the consumer 12 has sent the email with the image of the coupon 22 attached thereto to the merchant 14 is sufficient to entitle awarding of the benefit to the consumer 12.

It is important to note that the merchant 14 can change the coupon offering when desired and in any manner that is desired. A simple removal (i.e., deleting) of the image of the coupon 22 from the website is all that is required to delete the coupon 22 offering. To change the terms (i.e., for example, the benefit) of the coupon 22, a replacement image of the coupon 22 that includes the new terms is downloaded to the website and is used to replace the prior offering.

If desired, the merchant 14 can include multiple different offerings (i.e., presentations) of the coupon 22 at the website, with each offering differing to some degree in its terms. This approach can be useful in attracting a greater variety of the consumer 12 who may desire and thereby be more inclined to utilize the coupon 22 if presented with a plurality of the coupons 22, each of which provides a different product, service, or benefit. The system, as mentioned above, can also keep track of the different types or versions of the coupons 22 that are being redeemed and can perform any desired analysis regarding redemption patterns of the coupons 22.

Changes to the coupon 22 are instantaneous. Another benefit provided to the merchant 14 is the elimination of the long lead time that is associated with the printing and delivery of paper coupons.

It is also important to note that the consumer 12 will always be obtaining a current and valid type of the coupon 22. Merchants 14 may also be more inclined to inform unaware consumers 12 (i.e., customers) who come to their place of business that a discount in price or an increase in goods or services is available if the consumer 12 is willing to access the coupon 22 over the Internet 18 using their personal mobile computing device 16. The merchant 14 would then inform the consumer 12 as to the email address (i.e., URL) of the merchant's 14 website or other website where the address or URL of the coupon 22 can be obtained. It is useful to note that the consumer 12 mayor may not be aware that he or she is attaching the address or URL of the coupon 22 to the email that is sent to the merchant 14 and not an image of the coupon 22.

The merchant 14 will generally require the consumer 12 to use their own personal mobile computing device 16 because the merchant 14 desires receipt of the email from the consumer 12 for reasons as described in greater detail, hereinafter. However, the merchant 14 may have one or more merchant computing devices 16a that belong to the merchant 14 at the merchant's 14 place of business that are available for loan to the consumer 12. The merchant computing device(s) 16a would permit the consumer 12 to access the Internet 18 if they did not bring their own personal mobile computing device 16. However, the consumer 12 would generally be required to access the consumer's 12 own web mail provider and send the required email from their own Internet 18 web mail provider (i.e., thereby using their own email address/URL). This action step by the consumer 12, as is described in great detail below, automatically provides the merchant 14 with the email address of the consumer 12.

It is important to note that the way the address or URL of the coupon 22 is attached to the email is a variable that depends on many factors including, for example, the capabilities of the mobile computing device 16, the software (also known as a web browser) that the mobile computing device 16 uses for accessing the Internet 18, and how the website is configured (i.e., setup and programmed).

When the website is designed and constructed, the merchant 14 can instruct his or her web developer to configure the merchant's website (or the third party website that is to include the coupon 22) so that when the consumer 12, after using the mobile computing device 16 to access the appropriate web page on the website and see the image of the coupon 22, then uses a pointing device or way of pointing included with the mobile computing device 16 to point to the image of the coupon 22 on their display 19 and, after pointing to it, the consumer “clicks” (i.e., selects) the coupon 22.

At that point, depending on how the image of the coupon 22 is configured on the website and upon the limitations and capabilities inherent with the mobile computing device 16, that address or URL of the coupon 22 will be selected even if the consumer 12 clicked on an image of the coupon 22.

Alternately, the consumer 12 may be instructed by the merchant's website (when viewing the display 19 on the mobile computing device) to click or otherwise select some area on the web page other than the image of the coupon 22. When the instructed area on the merchant's 14 web page is selected, the mobile computing device 16 obtains the address or URL where the coupon 22 can be viewed.

The instructed area may be included in a visible field (as in a box visible on the display 19) or it may appear as any desired text message. For example, the instructed area (what the consumer 12 is instructed to select) may state something as simple as “Click here to obtain URL” or it may include the actual alpha-numeric characters that comprise the address or URL.

As certain cell phones and other types of the mobile computing device 16 are becoming increasing able to scan and interpret images of bar codes it is also possible to require the consumer 12 to select an encoded representation of the address or URL where the coupon 22 can be viewed. Any type of an encoding scheme or symbology can be used to encode and thereby contain the address or URL where the coupon 22 can be viewed.

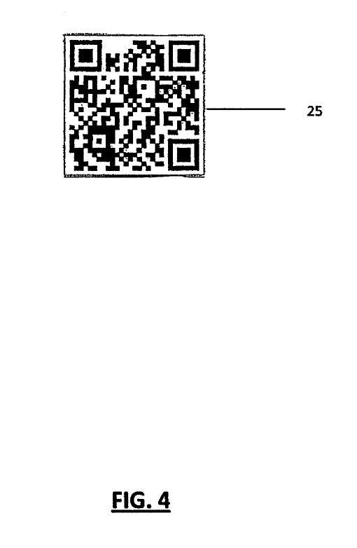

For example, referring to FIG. 4, a quick response symbol, referred herein as a QR Code 25 can be included in the merchant's 14 web page. The consumer can be instructed to select the QR Code instead of the actual image of the coupon 22 that also appears at the merchant's 14 web page. When the consumer 12 sends the coupon 22 confirming email that has the merchant's 14 QR Code 25 attached thereto, to the merchant's email address the consumer 12 is actually sending the address or URL where the coupon 22 can be viewed to the merchant 14, but in encoded form. The merchant 14 can, if desired, open the email attachments (manually or automatically) and by scanning the received QR Codes 25 quickly confirm that the proper address or URL has been received which, in turn, confirms that the consumer 12 has redeemed a valid type of the coupon 22.

It is the address or URL of the coupon 22, whatever the area the consumer 12 is asked to click on or otherwise select, that is attached to the email and then sent by email from the consumer 12 to the merchant 14. This provides a significant benefit or advantage to the consumer 12 in that transmission of the address or URL requires less time than that of the actual physical image of the coupon 22 or of the entire web page that includes the image of the coupon 22.

Accordingly, the consumer 12 pays less for air time which makes redemption of the coupon 22 less expensive. If the consumer 12 stays below the allotted number of minutes in whatever plan they are using to connect their cell phone or other type of mobile computing device to the Internet, then use of the instant invention to redeem the electronic type of the coupon 22 is without additional cost to the consumer 12.

Attachment will vary among the different types of the mobile computing device 16. For example, some of the Internet 18 browsers that are available for different cell phones (i.e., for different types of the mobile computing device 16) may include an “attach” command that is then used to attach the address or URL of the coupon 22 to the email. Different browsers may require that the consumer 12 first “copy” and then “paste” the address or URL of the coupon 22 to the email. Other browsers may require a different procedure or assign different names to the steps that are required, such as by “dragging and dropping” the address or URL of the coupon 22 to the email. As used herein, the terms “attach”, “attached”, “attachment”, and “attaching” are intended to encompass any and all variation in procedure and terminology necessary for including the desired address or URL of the coupon 22 with the email that is sent to the merchant 14.

By sending the email to the merchant 14 the consumer 12 is also automatically providing their email address to the merchant 14. However, the consumer 12 in all likelihood does not even know that they are doing so, as the consumer 12 is primarily focused on doing what is required to obtain the benefit provided by the coupon 22. In most instances, the consumer 12 is happy to send the email with the address or URL of the coupon 22 attached thereto to the merchant 14 because the consumer 12 feels that this action will produce an immediate gain (i.e., benefit) for the consumer 12 (i.e., whatever benefit is provided by the merchant 14 subsequent to a redeeming of the coupon 22).

In general, the merchant 14 is highly desirous of obtaining the email addresses of their customers (i.e., of their consumers 12). This information can be used to later communicate with their consumers 12. The merchant 14 can collect and store them and then use the email address of the consumer 12 for future advertising that is sent by email to the consumer 12.

The merchant 14 can also analyze and use the received emails for a variety of purposes. For example, the merchant 14 can analyze the time of transmission of the received emails to better assess business patterns. This provides the merchant 14 with the unexpected benefit of better being able to provide adequate staffing for peak periods as well as prevent overstaffing during slow periods. The merchant 14 can also track and analyze patterns of redemption of the coupon 22 to determine which incentives or benefits are most effective if included in the coupon 22. The merchant 14 can, as mentioned above, supply each employee with a unique email address of the merchant 14. The merchant 14 can compare the number of discounts that each employee awards to the consumers 12 with the number of emails (with the image of the coupon 22) that are received in each unique email address. This can be used to detect if any abuse in the awarding of the coupon 22 benefit is occurring and it can identify the individual employee or employees that are responsible for such types of abuse.

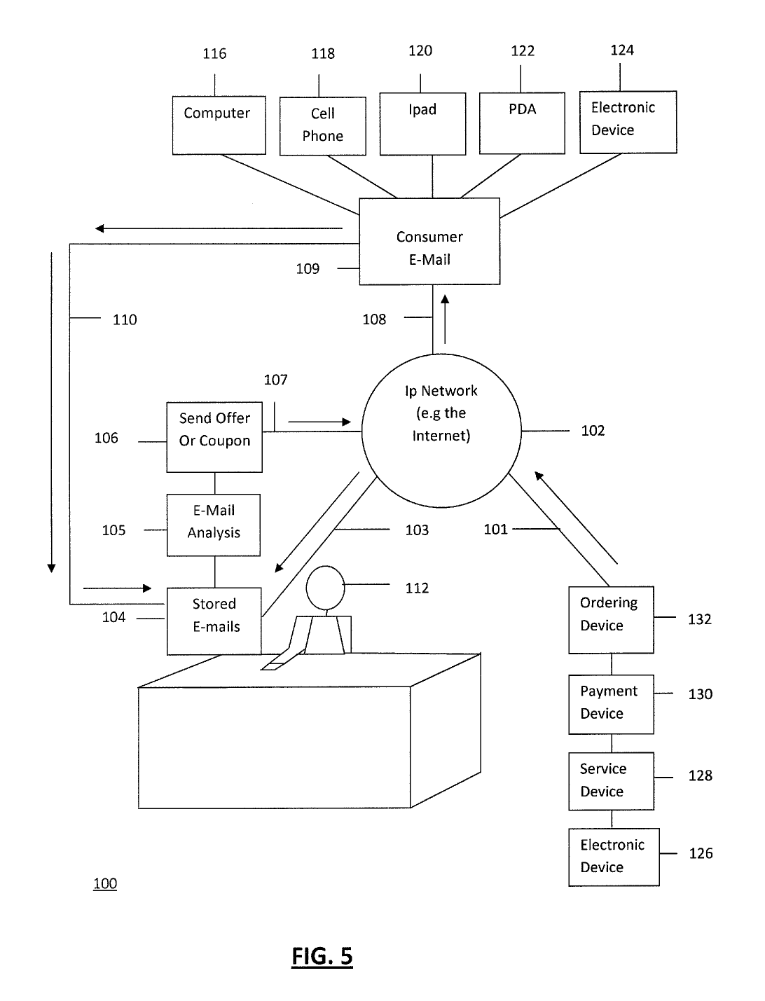

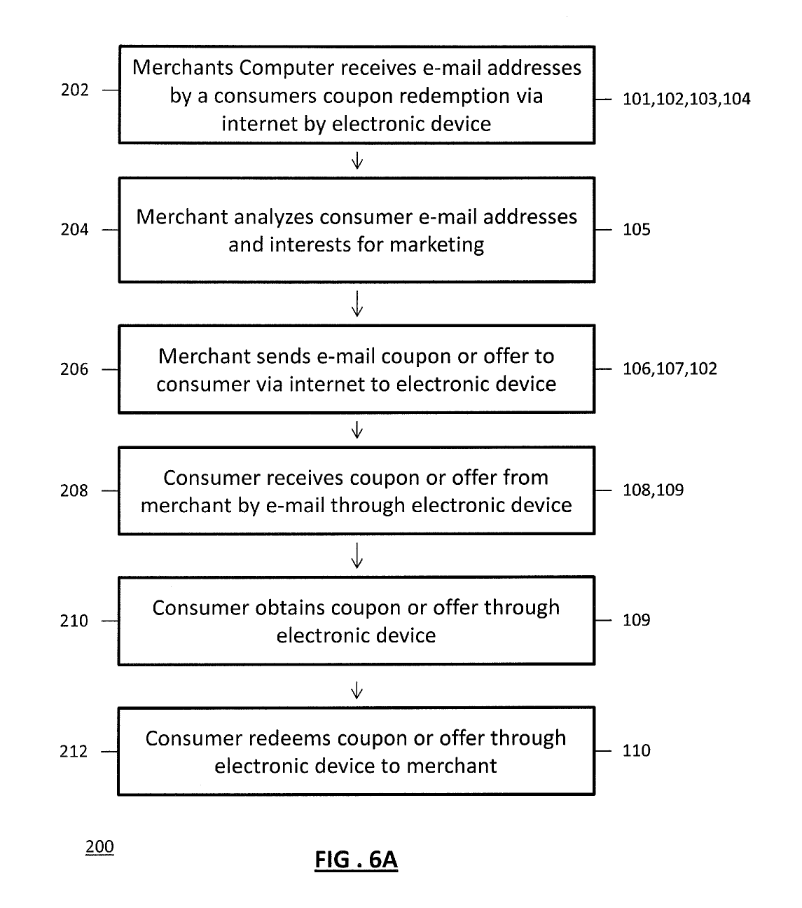

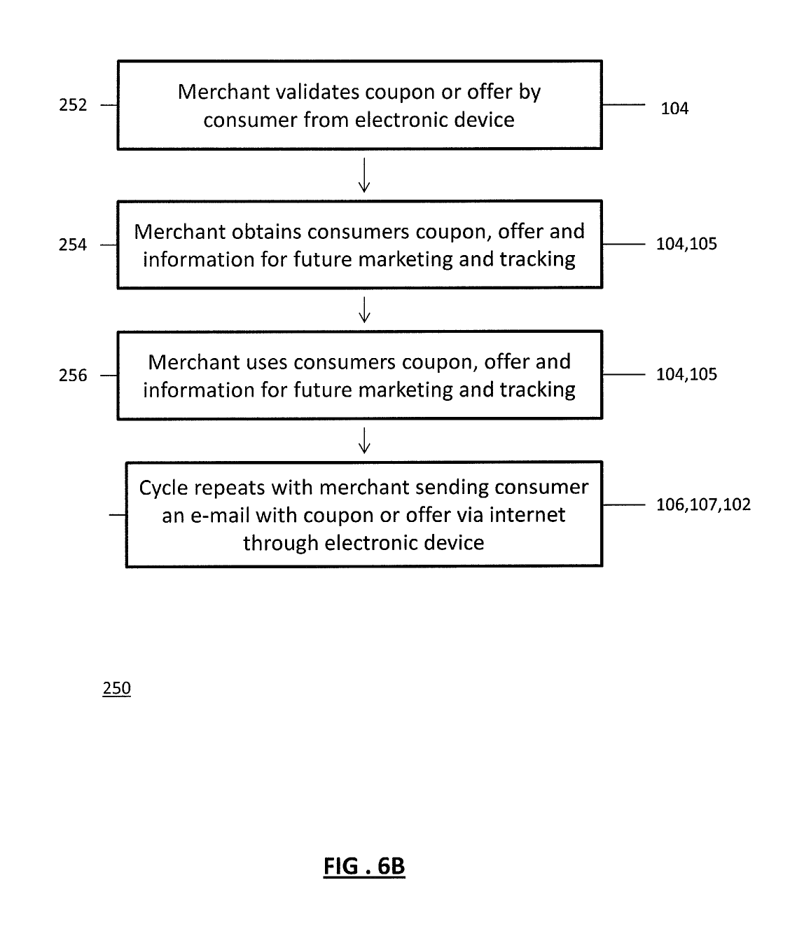

FIG. 5 is a block diagram of an embodiment of a merchant's system 100 to validate coupons and to accumulate and store emails sent by consumers redeeming the merchant's coupons, and to analyze the emails and email addresses to determine how the merchant can further benefit its business. FIG. 5 should be viewed in conjunction with flow diagrams shown in FIGS. 6A and 6B. FIG. 6A is a flow diagram 200 which shows how consumer emails are accumulated and stored by a merchant, how a merchant analyzes the emails and email addresses and determines what beneficial actions the merchant might engage in using the stored emails. FIG. 6B is a flow diagram 250 which shows how a merchant validates a consumer coupon and uses the consumers email information for future tracking. In FIGS. 6A and 6B the numbers at the right of each block of the flow diagrams corresponds to where the function described in the block takes place in the merchant's system 100 shown in FIG. 5.

Coupons or offers being redeemed by email travel to an IP network 102, such as the Internet, as shown figuratively by line 101. These emails travel to the merchant's system 100, as shown figuratively by line 103 to block 104 where consumer emails are accumulated and stored. FIG. 6A, block 202. Emails with coupons or offers to be redeemed come from consumer sources such as an ordering device 132, a payment device 130, a service device 128 or an electronic device 126. Electronic device 126 can be any electronic device capable of sending and receiving emails or communicate through the internet. Examples include a computer, a cell phone, an iPad or a PDA. Service device 130, payment device 132 and ordering device 132 are electronic devices used in a self-service fashion, to order an item, to make a payment, to send or receive a coupon or discount offer or to send or to or request a coupon offer by way of email from at a business location.

As an example, one well-known restaurant chain provides their customers with small electronic computers sitting on the table. From this computer one can order a meal off the menu without the waiter having to come to the table. One can pay your own bill using your credit card from it. Advertisements are provided on the computer and this may well be a vehicle for merchants to allow customers to redeem coupons, thereby providing their emails to merchants. Or they may be able to browse offers and redeem them from the table top computer.

At block 105 the emails and/or the email addresses are analyzed to determine how this information might be used to benefit the merchant's business or the merchant's interests. FIG 6A, block 204. At 106 the merchant sends a communication or an offer to the consumer's email server 109, via the Internet 102 shown figuratively as 107 and 108. An offer or a coupon can be sent to the consumer email server 109 through the internet 109. FIG. 6A, blocks 208 and 210.

The consumer can redeem a coupon or offer by sending an email identifying the coupon or offer to be redeemed via the consumer's email server 109 These emails are accumulated and stored at the merchant system 100 at 104. FIG. 6A, block 212. There are many electronic devices 124 which are available to a consumer to communicate with the merchant in this fashion. These include a computer 116, cell phone 118, iPad 120 and PDA 124.

After validating the coupon the merchant's system at 104 and 105 obtains and uses information from the stored emails for future marketing and tracking FIG. 6B, blocks 254 and 256. As new coupons, offers or communications are sent out via the internet to consumers by the merchant by email and are redeemed by the merchant the cycle repeats itself, potentially many times.

Referring additionally to FIG. 1, the emails sent by the merchant to the consumer communication can include a message to the consumer 12 that expresses appreciation to the consumer 12 for doing business with the merchant 14 by thanking the consumer 12. As such, it can be used to deepen the relationship (increase trust and intimacy) between the merchant 14 and the consumer 12. Or the communication can be used to inform the consumer 12 of any type of a sale or discount that the merchant 14 is offering or will be offering when the merchant 14 has reason to believe that the consumer 12 would want to be so informed. In this way, the merchant 14 is able to target advertising to the most likely group of the consumers 12 and to do so at very low cost and at the exact desired time(s). The email-based advertising may include a simple notification of an upcoming sale or it may include notification of a new type of the coupon 22 that is (or will become) available or notification of new goods or services from the merchant 14.

By the voluntary providing of the consumer's 12 email address to the merchant 14, the merchant 14 does not have to resort to general or mass mailing which is a form of advertising that occurs at significantly elevated cost levels. Obtaining the consumer's 12 email address also saves the merchant 14 of having to distribute by way of general mass-marketing advertising and other incentives (i.e., other paper coupons) to a broad spectrum of people, many of whom will not be customers of the merchant 14 or even interested in the goods or services of the merchant 14. This greatly reduces expense to the merchant 14. By way of comparison, the merchant's 14 use of email addresses obtained from the consumer's 12 email transmissions to the merchant 14 comprise a group of known customers and therefore provide the merchant 14 with an ideally targeted customer base to solicit.

Similarly, the merchant 14 may be spared the expense of having to purchase a data base of possible clients for solicitation (by direct mailing) from a supplier of such types of data bases. Not only is the merchant 14 spared of the cost of purchasing the data base, the merchant 14 is also spared of the very high cost of mailing an advertisement or paper coupon directly to each of the people listed on the data base.

Therefore, by using the method for redeeming electronic coupons 10, the merchant 14 decreases or even eliminates the need to try and solicit the consumer's 12 email address and possibly risk, as a result of asking, offending the consumer 12 or creating ill-will between the consumer 12 and the merchant 14.

As a result of using the method for redeeming electronic coupons 10, physical reality is altered and changed because the consumer 12 gets to enjoy whatever benefit is offered by the coupon 22, the same as if the consumer 12 were instead presenting a current, valid paper version of the coupon 22 to the merchant. This results in a physical transformation by which for the same money the consumer 12 obtains additional goods and services than he or she would were it not for the instant invention. Additionally, the method for redeeming electronic coupons 10, by obviating the need for paper coupons, lessens the need for paper which, in turn, saves trees. Less C02 is emitted into the atmosphere because less paper is being used. Most paper coupons will eventually end up being burned, thereby directly adding to atmospheric C02 levels, or they will be deposited in landfills where they will decay over time, thereby also increasing atmospheric C02 levels. The instant invention thereby reduces greenhouse gas levels which results in a positive transformation of the quality of the atmosphere.

It is also an added unexpected benefit that use of the method for redeeming electronic coupons 10 actually helps remove C02 from the atmosphere. This is because fewer trees will need to be cut because consumers 12 using the method for redeeming electronic coupons 10 will have no need for these paper coupons. The resulting increase in the number of uncut and still living trees will continue to pull C02 out of the atmosphere as they continue to grow as opposed to being converted into paper coupons and further increasing the quantity of atmospheric C02 (i.e., greenhouse gases) and global warming (i.e., climate change).

It is, of course, also to be understood that in order to function as described herein, any version of the mobile computing device 16 must include some type of a processing chip such as a microprocessor chip or a microcomputer chip and the necessary operating software.

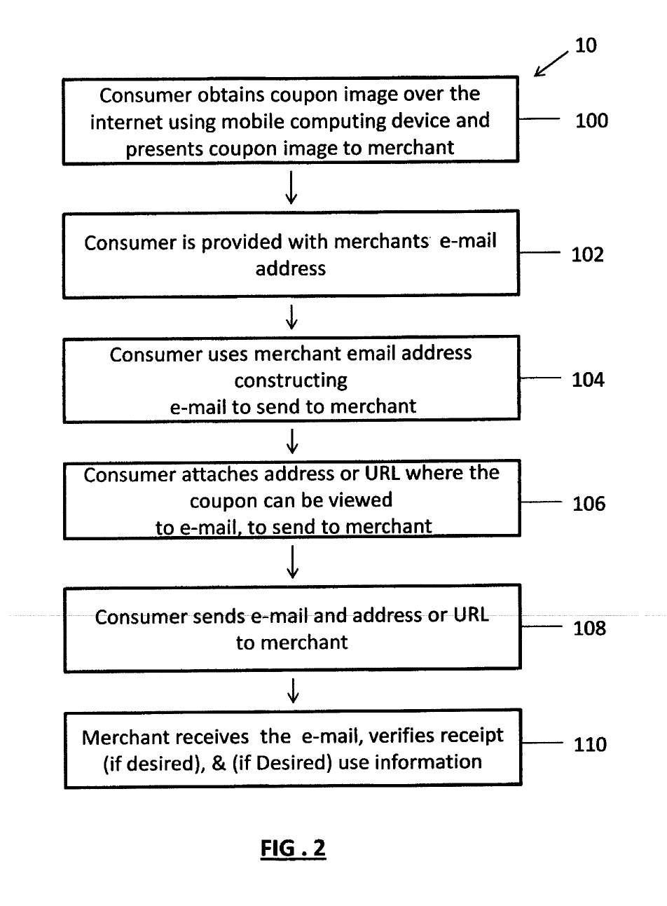

Referring in particular to FIG. 2, the various steps of the method for redeeming electronic coupons 10 are shown.

The first step is that of the consumer 12 obtaining an image of the coupon 22 over the Internet 18, and that step is identified in general by the reference numeral 100. Of course, the consumer 12 must either know or be provided with the email address (i.e., URL) of a location accessible over the Internet 18 where the image of the coupon 22 can be found.

For most situations, the consumer 12 will also present the image of the coupon 22, as seen on the display 19 of their portable and personal mobile computing device 16 to the merchant 14 for verification. If desired, the merchant 14 may not require any viewing of the image of the coupon 22 on the mobile computing device's 16 display 19 by the merchant 14 or by an employee of the merchant 14. However, by requiring the consumer 12 to obtain the image of the coupon 22 on the display 19 of their mobile computing device 16 this ensures that the image of the coupon 22 is available for presentation to (i.e., for viewing by) the merchant 14 or employee of the merchant 14 should its viewing be desired or required by the merchant 14.

The second step is to provide the consumer 12 with the email address of the merchant 14, and that step is identified in general by the reference numeral 102. Each employee of the merchant 14 may have their own unique email address in which case each employee would provide the consumer 12 with their own email address. This, the employee would do, so that the merchant 14 (who has access to the content of any and all such email addresses) can verify that the employee acted properly (i.e., was authorized) when providing the benefit of the coupon 22 to the consumer 12.

The third step requires the consumer 12 to begin construction of an email that is to be sent to the email address that was provided by the merchant 14, and that step is identified in general by the reference numeral 104. The consumer 12 does not need to list any subject in a subject field or add any text to the email.

The fourth step requires the consumer 12 to attach an address or URL where the coupon 22 can be viewed. If the merchant 14 were to select the address or URL received along with the consumer's 12 email, the merchant's 12 computer would go the address or URL on the Internet where the actual image of the coupon 22 would be available for viewing by the merchant 14. Such viewing provides another way for the merchant 14 to confirm that a valid version of the coupon 22 was presented at the time of its redeeming. This step is identified in general by the reference numeral 106. Of course, in order to do this, the consumer 12 must first have navigated over the Internet 18 to the proper web page at a web site that includes the desired image of the coupon 22.

If desired, some flexibility in the sequence of steps is possible. For example, the first step could include providing the consumer 12 with the email address of the merchant 102, followed either by the consumer 12 obtaining the coupon's 22 image 100 or by the consumer 12 beginning construction of the email 104.

The fourth step of attaching the Internet address or URL of the coupon 22 to the email 106 is accomplished after the first three steps have been accomplished in their preferred sequence.

After having attached the address or URL of the coupon 22 to the email, the fifth step is accomplished which requires the consumer 12 to then send or transmit the email to the merchant's 14 email address, and that step is identified in general by the reference numeral 108.

The sixth step to complete the process is receipt of the email by the merchant 14, and that step is identified in general by the reference numeral 110. However, verification that the sixth step 110 has, in fact, occurred is not generally required in order for the consumer 12 to receive the benefit provided by redemption of the coupon 22.

If desired, the merchant 14 can confirm that receipt of the email from the consumer 12 has occurred before providing the benefit to the consumer 12. If desired, the merchant 14 can additionally confirm receipt of the a proper and valid address or URL where an image of the coupon 22 is available over the Internet for viewing has also occurred before providing the benefit to the consumer 12.

Accordingly, the method for redeeming electronic coupons 10 provides numerous benefits to both the consumer 12 and the merchant 14, some of which are especially significant and unexpected when compared with prior art methods of using paper coupons.

It is, of course, to be understood that communication involving the Internet 18 can include any preferred or suitable language, standard, or protocol that facilitates the exchange of information. For example, “HTML”, which stands for “Hypertext Markup Language”, is a common language for use on the Internet 18. Another possible language or variation to a language is referred to as XML. “XHTML”, which stands for “Extensible Hypertext Markup Language” and is a hybrid between HTML and XML, may facilitate device display on different platforms. Certain of the possible languages for use involving the Internet 18 have dif rent versions, some of which may be better suited for the exchange of text information while others may be better suited for the exchange and display of images on a variety of different devices. For example, HTML through HTML 5 are especially useful versions for the exchange of text information. Accordingly, the method for redeeming electronic coupons 10 can utilize any current language or version thereof, as well as any future language or version thereof that may be developed.

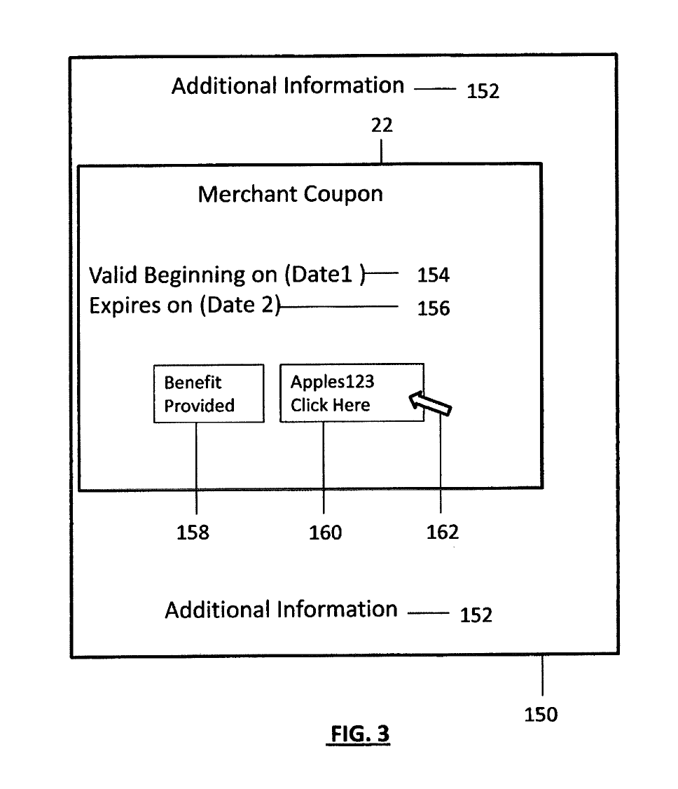

Referring now also to FIG. 3 is shown an image of the coupon 22 as it might appear when accessing a web page on the merchant's 14 website or on other websites authorized by the merchant 14 to offer the coupon 22 to the public. Once accessed, the coupon 22 would be visible on the display 19 of the mobile computing device 16. It is to be understood that, if desired, one or more variations (not shown) of the coupon 22 can also be offered simultaneously at the website along with the coupon 22. Each of the variations could provide a different type of a benefit, thereby permitting the consumer 12 to select and attach whatever version of the coupon 22 was most desired at the time.

The coupon 22 might be included as a part of an entire webpage 150 (or homepage) in which case additional information 152 could also appear (be visible) along with the coupon 22. The additional information 152 would include whatever the merchant 14 desired, such as a telephone number, address, hours of operation, or photograph(s) of the merchant's 14 place (or places) of business, etc.

A version of the coupon 22 might include a starting date of the coupon 22, identified herein as “Date 1 154” and/or an expiration date of the coupon 22, identified herein as “Date 2 156” or they could be eliminated. If the merchant 14 wanted the coupon 22 to expire the merchant 14 would simply remove it from the web page, after which it would no longer be available for use by the consumer 12. This allows the merchant 14 to provide a type of the coupon 22 that, if properly obtained and presented to the merchant 14 by the consumer 12, is certain to be valid and to not have expired. In addition, the merchant 14 can, at will, cause any coupon offering to expire by simply deleting the coupon image 22 and/or the address or URL of the coupon 22 from the web page. In this manner two seemingly contradictory objectives are simultaneously satisfied.

The coupon 22 would typically include a description of a benefit 158 that is provided to the consumer 12 if the coupon 22 is timely redeemed. For example, let us assume that the consumer 12 is provided with a free apple (not shown) when the coupon 22 is redeemed.

The coupon 22 can also include a visible number or code 160 that identifies the type of the coupon 22 to the merchant 14. The visible number or code 160 can, if desired, include a border, as shown.

To attach the address or URL of the coupon 22 to the email (step 104, FIG. 2), the consumer 12 would move a curser 162 using a pointing device of the mobile computing device 16 to any area on the webpage 150, as instructed. The merchant 14 has discretion as to what portions of the webpage 150 where the coupon 22 is located (and visible for viewing) will include the address or URL of the coupon 22 that is to be attached to the email. It is important to remember and again take note that the actual image of the coupon 22 or any portion of the image of the coupon 22 is not being sent to the merchant 14. Only the address or URL of the coupon 22 is what the consumer 12 is attaching to the email that is sent to the merchant 14.

If desired by the merchant 14, the website could be constructed so that if the consumer 12 were to place the curser 162 (or other pointing device of the mobile computing device 16) anywhere within the webpage 150 and select what appeared to be the entire webpage 150, only the address or URL of the coupon 22 would, in fact, be attached to the email that is to be sent to the merchant 14.

It is possible to configure the webpage 150 so that by disposing the curser 162 anywhere on the webpage 150 and by clicking or selecting any area on the webpage 150 that only the address or URL of the coupon 22 is actually selected and attached to the email. Alternately, the consumer 12 could be instructed to dispose the curser 162 within the border of the coupon 22 (or within the border of the desired type of the coupon 22 if multiple versions of the coupon 22 are also present on the webpage 150) and after having properly moved the curser 162 to the desired area, then click (or select) the image of the coupon 22 which would then attach an address or URL of the selected coupon 22 (if several coupons 22 are on the merchant's website) to the email.

The consumer 12 does not need to know that the address or URL of the coupon 22 is being attached to the email. The consumer 12 merely follows any instructions that may be given and makes the attachment by whatever means (clicking, cutting and pasting, etc.) is operable for their version of the mobile computing device 16.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

What is claimed is:

1. A method for redeeming a merchant's electronic coupon by a consumer and providing email addresses of consumers while redeeming a coupon to the merchant for the benefit of the merchant using an Internet, comprising the steps of:
a) obtaining at least a portion of an image of the coupon by a consumer;
b) providing the consumer with an email address of the merchant;
c) using the email address of the merchant to construct an email by the consumer to send to the merchant;
d) attaching the image or portion of the image of the coupon to the email by the consumer;
e) sending the email to the merchant by the consumer;
f) receiving the email by the merchant
g) accumulating and storing the email addresses of a plurality of consumers by the merchant from the emails that are received by the merchant seeking redemption of an electronic coupon; and
h) analyzing the stored emails to determine what responses might be sent to consumers that would benefit the merchant;

2. The method of claim 1 wherein a redeemed coupon provides the consumer with benefits and wherein the step of receiving the email by the merchant includes the step of verifying receipt of the email by the merchant prior to authorizing or awarding the benefit as provided by the coupon to the consumer.

3. The method of claim 2 wherein the step of verifying receipt of the email by the merchant includes the step of verifying receipt of said at least a portion of the image of the coupon by the merchant prior to authorizing or awarding the benefit as provided by the coupon to the consumer.

4. The method of claim 3 wherein the step of using the stored email addresses of the plurality of consumers includes the step of sending an email to the email address of one or more of the stored consumer email addresses by the merchant.

5. The method of claim 4 wherein the step of sending an email to the email address of one or more consumers includes the step of sending a promotional communication to a consumer.

6. The method of claim 4 wherein the merchant generates solicitations relating to price of goods and services and wherein the step of sending the communication to at least one of the consumers includes the step of sending a solicitation to such consumers relating to price of goods or services.

7. The method of claim 4 wherein the step of sending an email to at least a portion of the email addresses includes the step of sending a communication to at least a portion of the stored email addresses of the plurality of consumers.

8. The method of claim 4 wherein the merchant generates solicitations relating to prices of goods and services and includes the step of sending a solicitation to at least a portion of the email addresses of the plurality of consumers, wherein the solicitation includes a revised electronic coupon or a notice about a sale or other change in the price of goods or services offered by the merchant.

9. The method of claim 4 wherein the step of obtaining at least a portion of an image of the coupon includes displaying at least a portion of said image of the coupon on a display of a mobile computing device.

10. The method of claim 9 wherein the step of displaying at least a portion of said image of the coupon on said display of said mobile computing device includes the step of showing at least a portion of said image of the coupon on said display to the merchant or to an employee of the merchant prior to the step of sending the email to the merchant.

11. The method of claim 10 wherein the step of displaying said at least a portion of the image of the coupon on said display of said mobile computing device includes the step of displaying at least a portion of said image of the coupon on a cell phone.

12. The method of claim 4 wherein the step of obtaining at least a portion of the image of the coupon includes the step of displaying said at least a portion of the image of the coupon on a display of a cell phone or on a display of a mobile computing device.

13. The method of claim 12 wherein the step of displaying said at least a portion of said image of the coupon on said display of said cell phone or on said display of said mobile computing device includes the step of displaying said at least a portion of said image of the coupon on said display of said cell phone and wherein said cell phone includes a microprocessor or a microcomputer or of displaying said at least a portion of said image of the coupon on said display of said mobile computing device and wherein said mobile computing device includes a microprocessor or a microcomputer.

14. The method of claim 4 including the step of providing a coupon in the form of a URL by the merchant and wherein sending the email to the merchant by the consumer with the URL address of the chosen coupon from the merchant's website of the desired coupon.

15. The method as in claim 4 wherein the step of including in the email to the consumer a link to the merchant's website includes sending a quick response symbol (QR) to the consumer and includes the step of sending a quick response symbol (QR code) of the chosen coupon in the email to the merchant.

16. A method for redeeming a merchant's electronic coupon or offer by a consumer and providing email addresses of consumers to a merchant for the additional benefit of the merchant using an Internet, comprising the steps of:
a. sending an email to the merchant indicating what coupon the consumer wants to redeem;
b. redeeming the coupon or offer for the selected goods or services if it is valid;
c. accumulating and storing the emails received by the merchant from consumers seeking redemption; and
d. analyzing the stored emails to determine what responses might be sent by email to consumers that would benefit the merchant.

17. The method of claim 16 wherein the step of analyzing the stored emails to determine what responses might be sent to consumers includes the step of sending an email to the email address of one or more of the stored consumer email addresses by the merchant.

18. The method of claim 17 wherein the step of sending an email to the email address of one or more of the stored consumer email addresses includes the step of sending a promotional communication to the consumer.

19. The method of claim 17 wherein the merchant generates solicitations relating to price of goods and services and wherein the step of sending the communication to at least one of the stored email address includes the step of sending a solicitation to such consumers relating to price of goods or services.

20. The method of claim 17 wherein the step of sending an email to at least a portion of the stored email addresses includes the step of sending a communication to at least a portion of the stored email addresses of the plurality of consumers.

21. The method of claim 17 wherein the merchant generates solicitations relating to prices of goods and services and includes the step of sending a solicitation to at least a portion of the email addresses of the plurality of consumers, wherein the solicitation includes a revised electronic coupon or a notice about a sale or other change in the price of goods or services offered by the merchant.

22. The method of claim 16 wherein the step of analyzing the stored emails includes the step of analyzing the time of transmission of the stored emails to assess business patterns.

23. The method of claim 16 wherein the step of analyzing the stored emails includes the step of tracking and analyzing patterns of redemption of coupons.

24. The method of claim 16 wherein the step of analyzing the stored emails includes targeting groups of consumers most likely to be interested in the merchant's products or services.
